(19) United States
(12) Patent Application Publication
(10) Pub. No.: US 2005/0222957 A1
(43) Pub. Date: Oct. 6, 2005

(54) Multi-depository financial transactions

(76) Inventor: Norman Understein, Potomac, MD (US)

Correspondence Address: NIXON & VANDERHYE, PC, 901 NORTH GLEBE ROAD, 11TH FLOOR, ARLINGTON, VA, 22203, US

(21) Appl. No.: 10/510,123

(22) PCT Filed: Mar. 6, 2003
(86) PCT No.: PCT/US03/06626

§ 371 Date: Oct. 4, 2004

Related U.S. Application Data
(60) Provisional application No. 60/362,086, filed on Mar. 7, 2002.
(60) Provisional application No. 60/422,496, filed on Oct. 31, 2002.

(51) Int. Cl. G06F 17/60

(52) U.S. Cl. 705/43

(57) ABSTRACT

A system facilitates processing of funds between a transferor and a transferee, where at least the transferor has a transferor deposit sub-account administered via a depository administrator. The transferor accesses the depository administrator via a global network. The transferor can request a transfer or hold of funds in the transferor deposit sub-account to or for the benefit of the transferee. If the transferee does not have a transferee deposit sub-account administered via the depository administrator, the transferee is provided an opportunity to establish the transferee deposit sub-account. Subsequently, the depository administrator processes the funds between the transferor deposit sub-account and the transferee deposit sub-account. With the addition of automated teller machine access to respective customer deposit sub-accounts, users can more easily deposit or withdraw funds from their own account or effect a transfer of funds to another account via Internet access. The transfer of funds can also be linked to the occurrence of a particular event or the like, such as product delivery, service completion, etc. Transferees may be notified of the transfer or hold of funds for their benefit via e-mail or the like.

This application claims the benefit of U.S. Provisional Patent Application Ser. No. 60/362,086, filed Mar. 7, 2002, and U.S. Provisional Patent Application Ser. No. 60/422,496, filed Oct. 31, 2002, the entire contents of which are herein incorporated by reference.

### BACKGROUND OF THE INVENTION

Funds are typically transferred between parties via checks, Fedwire, credit cards, wire transfers and the like. Such transfers require the participation of a third party individual such as a bank or account representative or a significant amount of time, for example in the case of checks where a receiving bank must present the check to the account-holder bank, etc. It would be desirable to implement a system that quickly facilitates transfer of funds from party to party without requiring a third party individual, for example by using a conventional automated teller machine (ATM), or the like. Currently, ATM's function to facilitate making withdrawals and deposits into a bank account or other account established at a financial institution. ATM's are not usable to transfer money between parties.

The Fedwire funds transfer system is a real-time gross settlement system in which more than 9,000 depository institutions initiate funds transfers that are immediate, final, and irrevocable when processed. Depository institutions that maintain a reserve or clearing account with a Federal Reserve Bank may use Fedwire to send payments to, or receive payments from, other account holders directly. Depository institutions use Fedwire to handle large-value, time-critical payments, such as payments for the settlement of interbank purchases and sales of federal funds; the purchase, sale, and financing of securities transactions; the disbursement or repayment of loans; and the settlement of real estate transactions. In the Fedwire funds transfer system, only the originating financial institution can remove funds from its Federal Reserve account. Originators provide payment instructions to the Federal Reserve either on line or off line. On-line participants send instructions through either a mainframe or PC connection to Fedwire, and no manual processing by the Federal Reserve Banks is necessary.

Off-line participants give instructions to the Reserve Banks by telephone; once the telephone request is authenticated, the Reserve Bank enters the transfer instruction into the Fedwire system for execution. The manual processing required of off-line requests makes them more costly, and thus they are suitable only for institutions with small, infrequent transfers. In 1999, the Federal Reserve System consolidated all off-line processing at the Kansas City and Boston Reserve Banks.

The Fedwire funds transfer system operates generally from 12:30 a.m. to 6:30 p.m. eastern time, Monday through Friday. The deadline for initiating third-party transfers (that is, transfers initiated by a depository institution on behalf of its customers) is 6:00 p.m. eastern time.

Financial institutions have used sub-account management systems where the account administrator holds a single bank account and administers multiple sub-accounts for their customers. These systems however, have no mechanism for enabling customers to transfer funds between sub-accounts via the Internet or other global network.

### SUMMARY OF THE INVENTION

The transactions encompassed with the present system include those between customers in an intra-depository environment, whereby one customer can have funds debited from his depository account and in real time have the funds credited to another customer's account in the same depository. An embodiment also effects transactions in an inter-depository environment, connecting customers with accounts at different depositories. Utilization of the system of the present invention enables Customer A to pay Customer B for items purchased or simply to easily transfer funds from Customer A to Customer B via Internet access to their respective deposit sub-accounts.

The system of the invention manages and administers multiple customer accounts via a sub-account management program. In this context, assuming for example the depository is a bank, the administrator will have a single bank account in which all funds are maintained. The administrator maintains multiple sub-accounts within the single bank account for its customers, maintaining separate balances, earning separate interest, incurring separate account fees, etc. From the customers' perspective, each customer has an independent account with its balance etc. accessible via the system of the invention.

In the inter-depository embodiment, customers anywhere in the world with access to a bank can have funds immediately credited to another account at any bank where the administrator has established a master account.

Another embodiment of the present invention enables customers anywhere in the world with access to a bank to have funds immediately put on Hold for the purchase of goods or other transaction, and the hold will be maintained by the system until certain pre-established criteria have been met, at which time the funds will be released as provided in the pre-established criteria.

In an exemplary embodiment of the invention, a method of processing funds between a transferor and a transferee is provided, where at least the transferor has a transferor deposit sub-account administered via a depository administrator. The method includes the steps of (a) the transferor accessing the depository administrator via a global network; (b) the transferor requesting a transfer or hold of funds in the transferor deposit sub-account to or for the benefit of the transferee; (c) if the transferee does not have a transferee deposit sub-account administered via the depository administrator, providing the transferee an opportunity to establish the transferee deposit sub-account; and (d) the depository administrator processing the funds between the transferor deposit sub-account and the transferee deposit sub-account.

Step (b) may further include enabling the transferor to input an E-mail address of the transferee, and where the method further comprises alerting the transferee via E-mail that the transfer or hold of funds has been requested. In this context, step (c) may be practiced by the depository administrator comparing the transferee E-mail address with stored E-mail addresses of deposit sub-account holders to thereby determine whether the transferee has an existing transferee deposit sub-account. If the transferee does not have a transferee deposit sub-account administered via the depository administrator, the step of alerting the transferee via E-mail preferably further includes providing a link to the depository administrator enabling the transferee to establish the transferee deposit sub-account. If the transferee has a transferee deposit sub-account administered via the depository administrator, the step of alerting the transferee via E-mail further preferably further includes providing a link to the transferee deposit sub-account.

Step (d) may be practiced by holding the funds in the transferor deposit sub-account until receiving confirmation that an event has occurred. The confirmation that an event has occurred may be confirmation by the transferor, confirmation of product delivery, confirmation of service completion, electronic confirmation by a third party such as a delivery or courier service (UPS, FedEx), etc.

In one embodiment, the depository administrator maintains multiple master accounts at multiple financial institutions, and step (d) is practiced by internally processing the funds between the transferor deposit sub-account as part of one master account and the transferee deposit sub-account as part of a different master account.

Automated teller machine (ATM) cards may be issued to holders of deposit sub-accounts, where the transferor and transferee can deposit funds or withdraw available funds via their respective ATM cards. In this context, the method may further include, prior to step (a), the transferor depositing funds into the transferor deposit sub-account using the transferor's ATM card, and after step (d), the transferee withdrawing funds from the transferee deposit sub-account via the transferee's ATM card.

The depository may be any suitable institution such as a bank, a retail establishment, or the like.

In another exemplary embodiment of the invention, a computer system for processing funds between a transferor and a transferee includes at least one user computer running a computer program that enables the transferor to access the depository administrator to request a transfer or hold of funds in the transferor deposit sub-account to or for the benefit of the transferee. A system server runs a server program, where the at least one user computer and the system server are interconnected by a computer network. The system server processes the funds between the transferor deposit sub-account and the transferee deposit sub-account, wherein if the transferee does not have a transferee deposit sub-account administered via the depository administrator, the system server providing the transferee an opportunity to establish the transferee deposit sub-account.

In yet another exemplary embodiment of the invention, a computer program is embodied on a computer-readable medium for processing funds between a transferor and a transferee, with at least the transferor having a transferor deposit sub-account administered via a depository administrator. The computer program includes structure for carrying out the method of the invention.

### BRIEF DESCRIPTION OF THE DRAWINGS

These and other aspects and advantages of the present invention will be described in detail with reference to the accompanying drawings, in which:

FIG. 1 is a detailed schematic illustration of a computer system;

FIG. 2 illustrates the system environment and application;

FIG. 3 is a sign up screen shot for registration with the depository administrator;

FIG. 4 is a screen shot enabling the user to send or reserve funds from their deposit sub-account;

FIG. 5 is a screen shot enabling the user to send money to a particular recipient/transferee;

FIGS. 6A and 6B illustrate transferee e-mail alerts;

FIG. 7 is a screen shot enabling the transferee to accept funds from the transferor;

FIG. 8 is a screen shot enabling the user to reserve funds for the benefit of a particular recipient/transferee;

FIGS. 9A and 9B illustrate transferee e-mail alerts relating to the reserved funds; and

FIG. 10 illustrates the system environment and application in an alternative embodiment of the present invention.

### DETAILED DESCRIPTION OF PREFERRED EMBODIMENTS

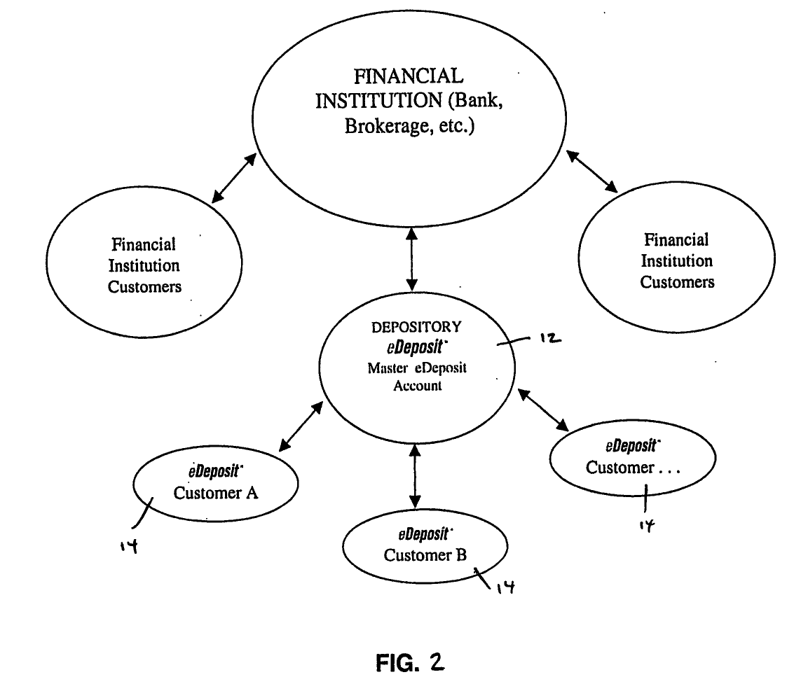

The multi-depository system described with reference to FIGS. 2-10 is preferably a browser-based system in which a program running on a user's computer (the user's web browser) requests information from a server program running on a system server. The system server sends the requested data back to the browser program, and the browser program then interprets and displays the data on the user's computer screen. The process is as follows:
1. The user runs a web browser program on his/her computer.
2. The user connects to the server computer (e.g., via the Internet). Connection to the server computer may be conditioned upon the correct entry of a password as is well known.
3. The user requests a page from the server computer. The user's browser sends a message to the server computer that includes the following:
   the transfer protocol (e.g., http://); and
   the address, or Uniform Resource Locator (URL).
4. The server computer receives the user's request and retrieves the requested page, which is composed, for example, in HTML (Hypertext Markup Language).
5. The server then transmits the requested page to the user's computer.
6. The user's browser program receives the HTML text and displays its interpretation of the requested page.

Thus, the browser program on the user's computer sends requests and receives the data needed to display the HTML page on the user's computer screen. This includes the HTML file itself plus any graphic, sound and/or video files mentioned in it. Once the data is retrieved, the browser formats the data and displays the data on the user's computer screen. Helper applications, plug-ins, and enhancements such as Java™ enable the browser, among other things, to play sound and/or display video inserted in the HTML file. The fonts installed on the user's computer and the display preferences in the browser used by the user determine how the text is formatted.

If the user has requested an action that requires running a program (e.g., a search), the server loads and runs the program. This process usually creates a custom HTML page “on the fly” that contains the results of the program's action (e.g., the search results), and then sends those results back to the browser.

Browser programs suitable for use in connection with the account management system of the present invention include Netscape® Navigator available from Netscape® Communications Corporation and Internet Explorer available from Microsoft® Corp.

While the above description contemplates that each user has a computer running a web browser, it will be appreciated that more than one user could use a particular computer terminal or that a “kiosk” at a central location (e.g., a cafeteria, a break area, etc.) with access to the system server could be provided.

It will be recognized by those in the art that various tools are readily available to create web pages for accessing data stored on a server and that such tools may be used to develop and implement the multi-depository system described below and illustrated in the accompanying drawings.

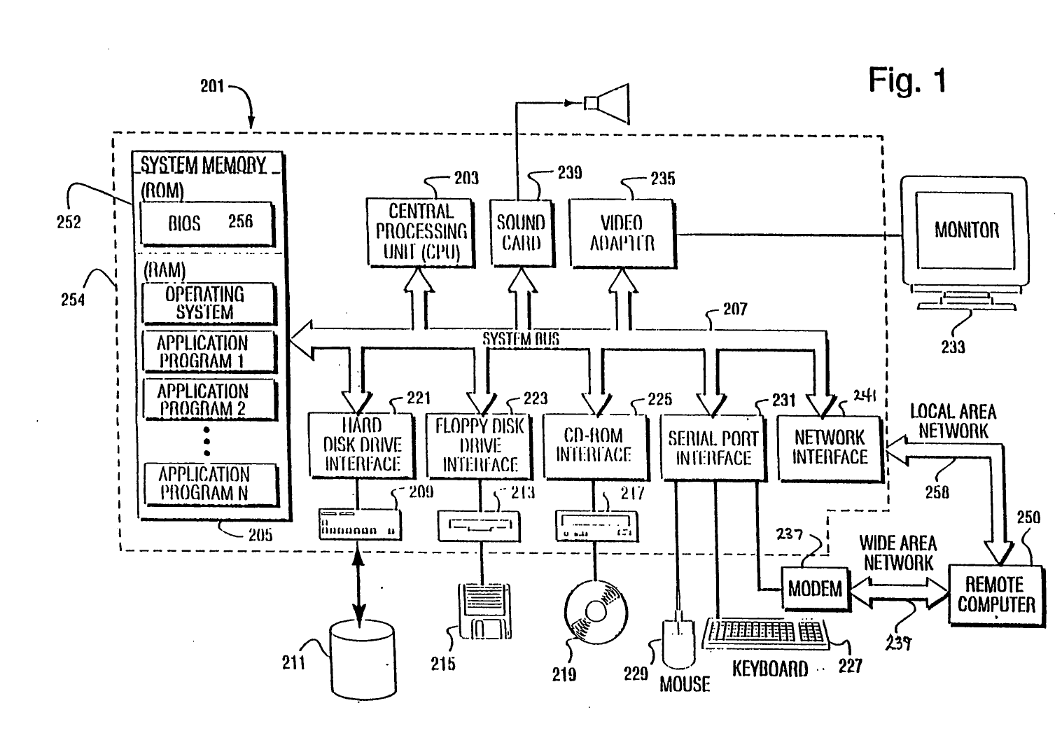

FIG. 1 generally illustrates a computer system 201 suitable for use as the client and server components of the multi-depository system. It will be appreciated that the client and server computers will run appropriate software and that the client and server computers may be somewhat differently configured with respect to the processing power of their respective processors and with respect to the amount of memory used. Computer system 201 includes a processing unit 203 and a system memory 205. A system bus 207 couples various system components including system memory 205 to processing unit 203. System bus 207 may be any of several types of bus structures including a memory bus or memory controller, a peripheral bus, and a local bus using any of a variety of bus architectures. System memory 205 includes read only memory (ROM) 252 and random access memory (RAM) 254. A basic input/output system (BIOS) 256, containing the basic routines that help to transfer information between elements within computer system 201, such as during start-up, is stored in ROM 252. Computer system 201 further includes various drives and associated computer-readable media. A hard disk drive 209 reads from and writes to a (typically fixed) magnetic hard disk 211; a magnetic disk drive 213 reads from and writes to a removable “floppy” or other magnetic disk 215; and an optical disk drive 217 reads from and, in some configurations, writes to a removable optical disk 219 such as a CD ROM or other optical media. Hard disk drive 209, magnetic disk drive 213, and optical disk drive 217 are connected to system bus 207 by a hard disk drive interface 221, a magnetic disk drive interface 223, and an optical drive interface 225, respectively. The drives and their associated computer-readable media provide nonvolatile storage of computer-readable instructions, SQL-based procedures, data structures, program modules, and other data for computer system 201. In other configurations, other types of computer-readable media that can store data that is accessible by a computer (e.g., magnetic cassettes, flash memory cards, digital video disks, Bernoulli cartridges, random access memories (RAMs), read only memories (ROMs) and the like) may also be used.

A number of program modules may be stored on the hard disk 211, removable magnetic disk 215, optical disk 219 and/or ROM 252 and/or RAM 254 of the system memory 205. Such program modules may include an operating system providing graphics and sound APIs, one or more application programs, other program modules, and program data. A user may enter commands and information into computer system 201 through input devices such as a keyboard 227 and a pointing device 229. Other input devices may include a microphone, joystick, game controller, satellite dish, scanner, or the like. These and other input devices are often connected to the processing unit 203 through a serial port interface 231 that is coupled to the system bus 207, but may be connected by other interfaces, such as a parallel port interface or a universal serial bus (USB). A monitor 233 or other type of display device is also connected to system bus 207 via an interface, such as a video adapter 235.

The computer system 201 may also include a modem 237 or other means for establishing communications over the wide area network 239, such as the Internet. The modem 237, which may be internal or external, is connected to the system bus 207 via the serial port interface 231. A network interface 241 may also be provided for allowing the computer system 201 to communicate with a remote computing device 250 via a local area network 258 (or such communication may be via the wide area network 239 or other communications path such as dial-up or other communications means). The computer system 201 will typically include other peripheral output devices, such as printers and other standard peripheral devices.

As will be understood by those familiar with web-based forms and screens, users may make menu selections by pointing-and-clicking using a mouse, trackball or other pointing device, or by using the TAB and ENTER keys on a keyboard. For example, menu selections may be highlighted by positioning the cursor on the selections using a mouse or by using the TAB key. The mouse may be left-clicked to select the selection or the ENTER key may be pressed. Other selection mechanisms including voice-recognition systems, touch-sensitive screens, etc. may be used, and the invention is not limited in this respect.

The architecture and system method will be described with reference to FIGS. 2-9. In accordance with the present invention, transactions between a transferor and a transferee can be processed via a depository administrator. The depository administrator generally maintains and administers a single master account 12 at a financial institution such as a bank. The master account 12 is subdivided into a plurality of deposit sub-accounts 14 for its respective customers. The administrator maintains the multiple sub-accounts 14 within the single bank account 12 for its customers, maintaining separate balances, earning separate interest, incurring separate account fees, etc. From the customer's perspective, each customer has an independent account with its balance etc. accessible via the system of the invention.

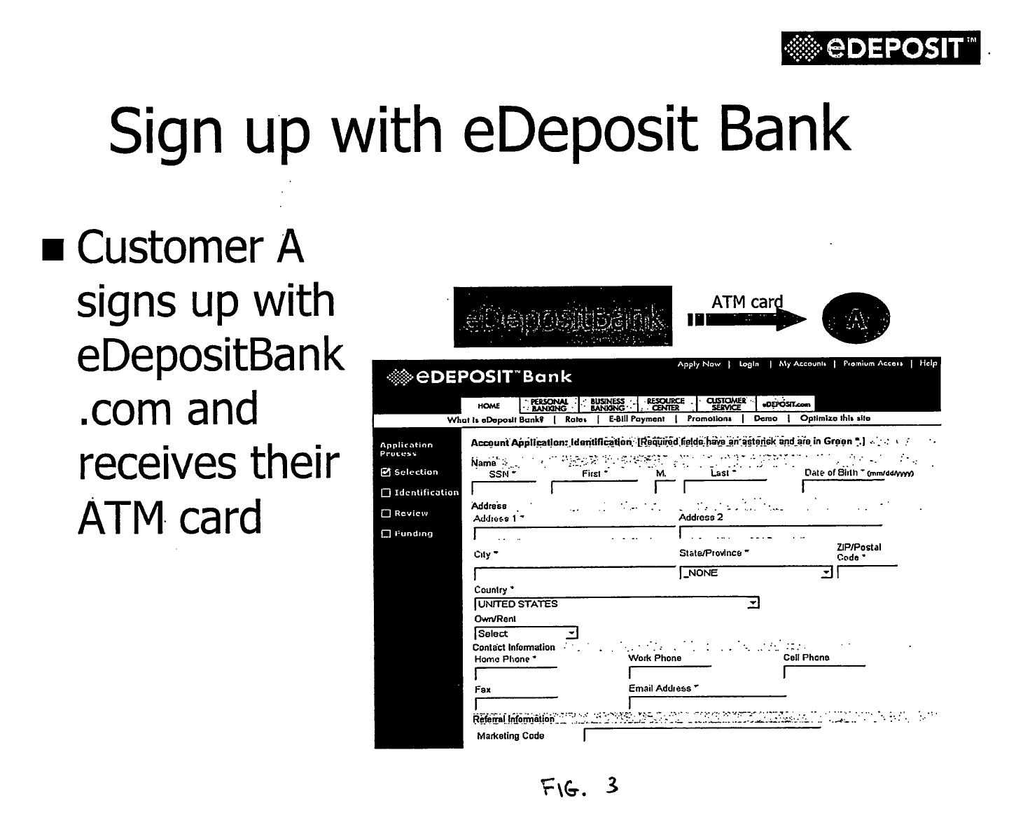

The system administered by the depository administrator is generally accessible via a global network, such as the Internet. With reference to FIG. 3, a new user can open a deposit sub-account 14 by accessing the depository administrator through the Internet. FIG. 3 is an exemplary sign up screen shot from which the user can open a new deposit sub-account 14. The system also directs the user on various ways in which the user can fund the deposit sub-account including, for example, check, wire, credit card, etc.

Once the deposit sub-account is established, the user can enter transactions with other parties using funds in their deposit sub-account or simply effect a transfer or reservation of funds in the deposit sub-account to or for the benefit of another party.

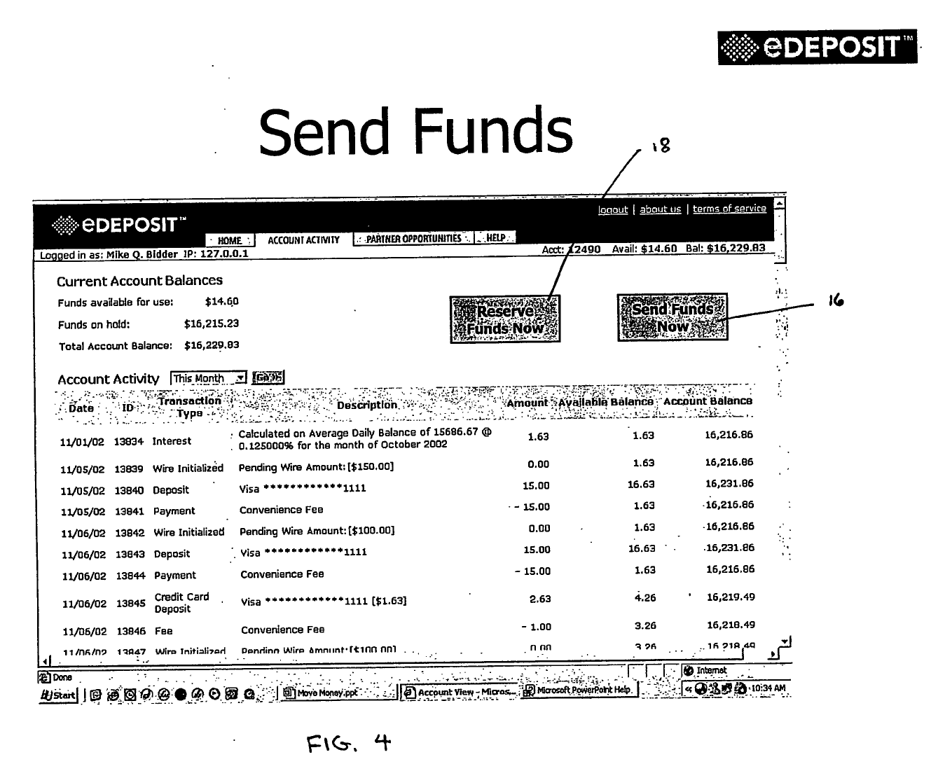

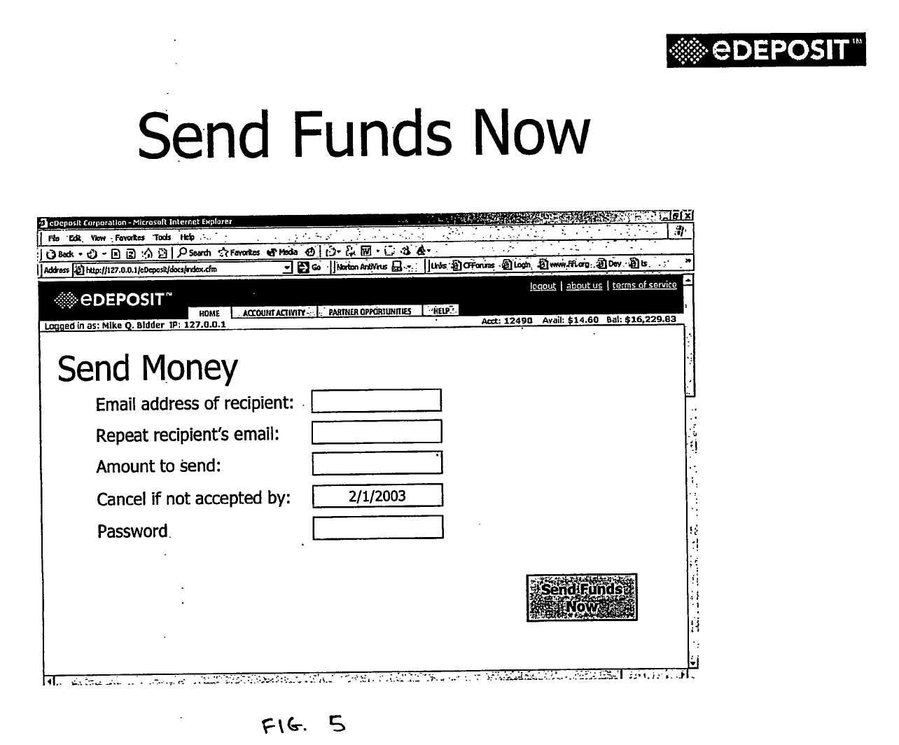

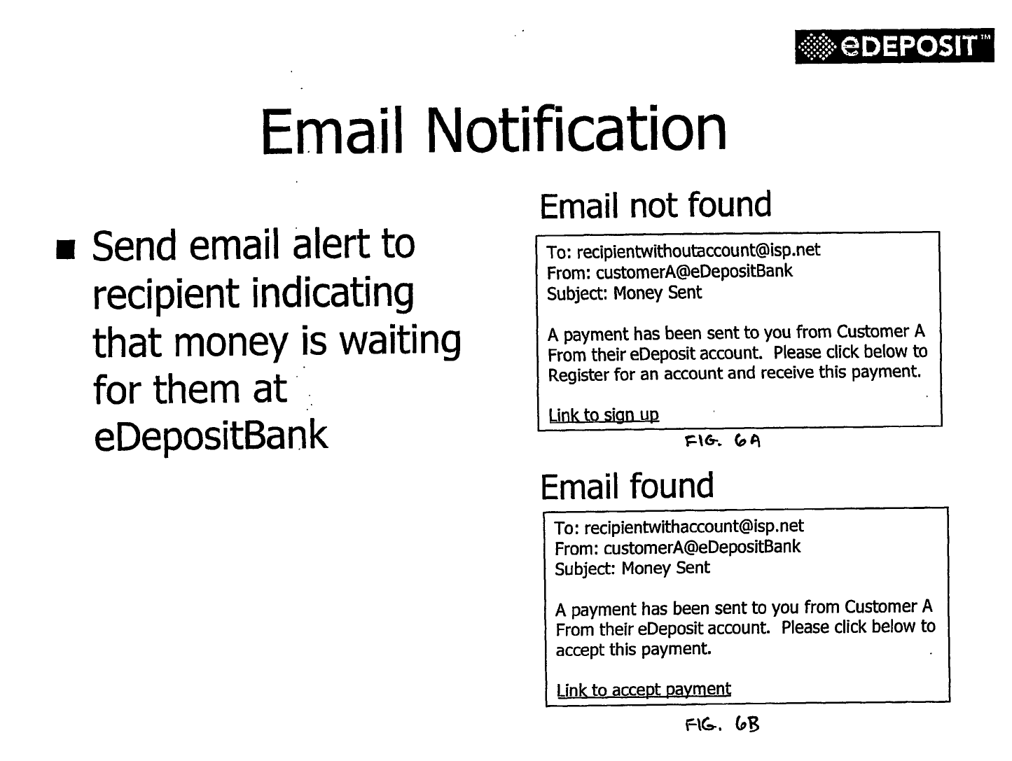

FIG. 4 is an exemplary account activity screen shot showing an available balance for transactions. The system enables the user to send or reserve available funds via links at 16, 18, respectively. When sending or reserving funds, the user, deemed transferor, requests a transfer or hold of funds in the transferor's deposit sub-account to or for the benefit of a transferee. If the transferor selects the link at 16 to send funds to a transferee, the screen may display the exemplary screen shot illustrated in FIG. 5. The transferor can complete the information requested by the system, including an e-mail address of the recipient/transferee. The system searches its database of e-mail addresses to determine whether the transferee already has a deposit sub-account administered by the depository administrator. If the transferee does not have a deposit sub-account, an e-mail such as that shown in FIG. 6A is sent to the transferee, including a link enabling the transferee to establish a deposit sub-account. In this manner, if the transferee selects the link, the transferee is directed to the sign up/registration section of the system, such as the exemplary screen shot of FIG. 3. If, on the other hand, the transferee has already established a deposit sub-account administered by the depository administrator, an e-mail such as that shown in FIG. 6B is sent to the transferee with a link to accept the payment/fund transfer.

In this context, when the transferor initiates any activity in their deposit sub-account 14, for example by designating funds to pay for goods or services purchased or simply to transfer funds to the transferee, the funds are transferred internally by the depository administrator from one sub-account 14 to another, still within the single master account 12. In such a transaction, the transferor would see a debit entry corresponding to the funds transferred, and the transferee would see a corresponding credit entry. The balance of the single master account 12 would be unchanged, since the transfer occurred internally.

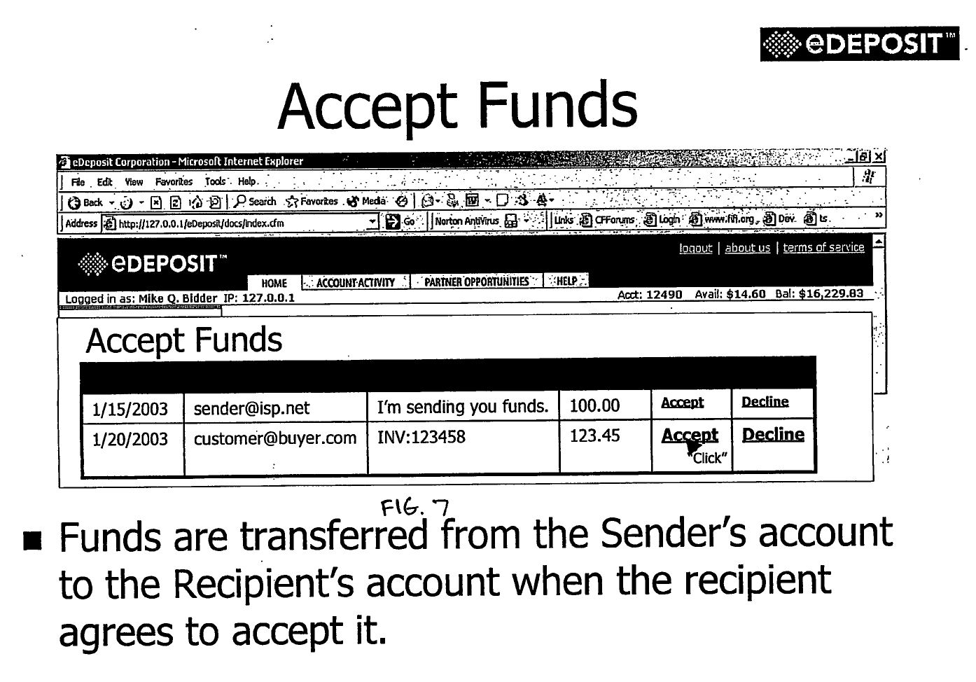

If the transferee selects the link to accept the funds, the transferee is directed to an appropriate section of the system such as the exemplary screen shot shown in FIG. 7.

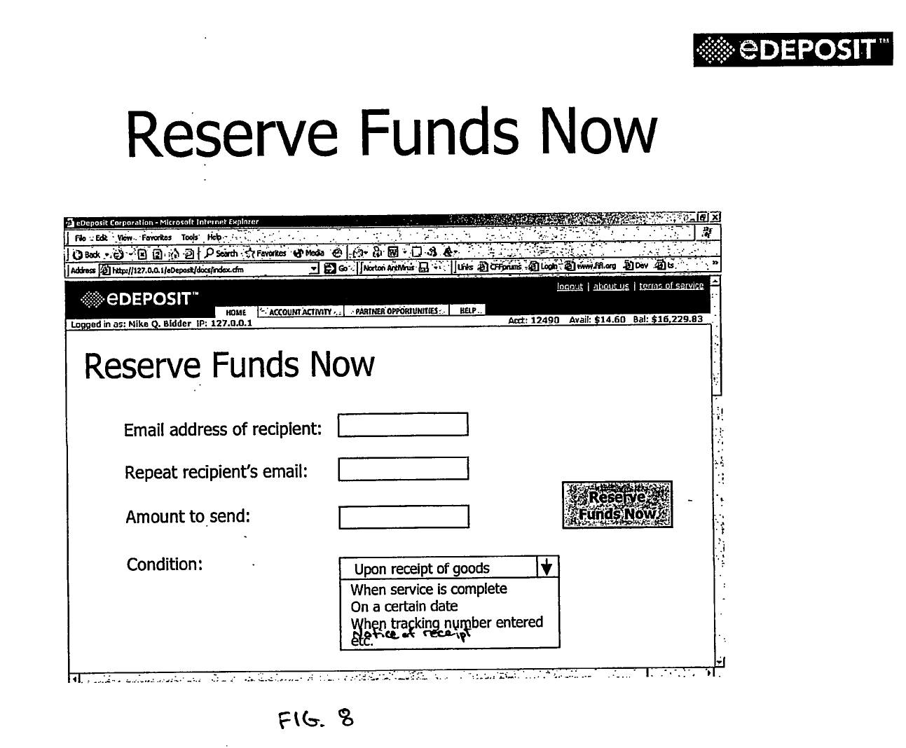

As noted, the transferor may alternatively reserve or hold funds for a pending transaction for the benefit of a particular transferee. In this context, if the transferor selects the link at 18 in FIG. 4, the transferor may be directed to a reserve/hold funds section of the system such as the exemplary screen shot shown in FIG. 8. In this manner, the transferor enters the transferee's e-mail address (or other identification), the amount of funds being reserved and some condition upon the occurrence of which the funds can be transferred. By holding funds in the transferor's deposit sub-account in this manner, the funds are made unavailable to the transferor, giving the transferee assurance that the funds will be transferred upon the occurrence of the predefined condition. Examples of such conditions may include upon the receipt of goods purchased, when service is complete, on a certain date, upon confirmation of delivery, etc. The ability to reserve funds is particularly suited for transactions where the seller/transferee requires a deposit or other assurance that funds are available prior to shipping the purchased goods, performing the requested service, etc.

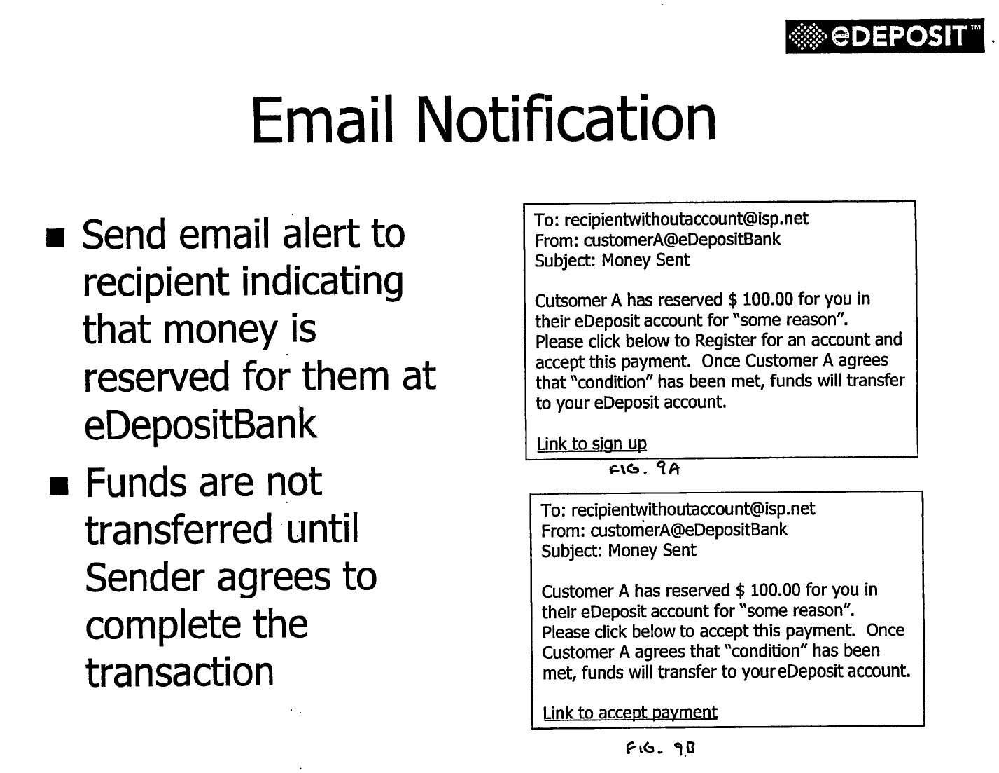

Once the funds have been reserved in the transferor's deposit sub-account 14, an e-mail alert is sent to the transferee indicating that money is reserved for them via the depository administrator. FIG. 9A illustrates an exemplary e-mail alert that may be sent to a transferee without a deposit sub-account administered by the depository administrator. FIG. 9B illustrates an exemplary e-mail alert sent to a transferee having already established a deposit sub-account. Preferably, the e-mail alert provides an indication to the transferee that funds have been held and will be transferred once the transferor agrees that a predefined event or condition has occurred.

The depository administered via the depository administrator, can be a bank, retail establishment or establishments or the like. In a retail establishment, a customer of retail store A deposits funds, which are processed through the system, and the customer of retail store B can receive funds that customer A has designated to customer B through the system.

Depositories such as banks typically maintain automated teller machines (ATMs), where customers can perform basic banking transactions, such as deposits, withdrawals, balance inquiries, etc. Customers are typically issued ATM cards and a personal identification code for use at the ATMs. In the context of the present invention, the depository administrator may issue ATM cards to holders of deposit sub-accounts 14 for access to the customer's respective sub-account 14. The cards may encompass debit or check cards or the like and typically contain conventional bank information as well as information for the depository administrator to identify the customer sub-account 14. With these ATM cards and the system of the present invention, a transferor can easily transfer funds to a transferee. For example, the transferor can deposit funds into his deposit sub-account via an ATM or any other conventional means, which funds are then designated for the transferee through the system of the present invention, and the transferee can then receive those funds via withdrawal at any ATM. That is, after depositing the funds, the transferor can access the system of the present invention via the Internet to effect a transfer of funds to the transferee. The system will then debit the transferor's account and credit the transferee's account in the amount authorized by the transferor. As noted, this transaction will not affect a balance of the depository administrator's master account 12 since the transfer occurs internally. The transferee can then withdraw the funds from any ATM in a conventional manner.

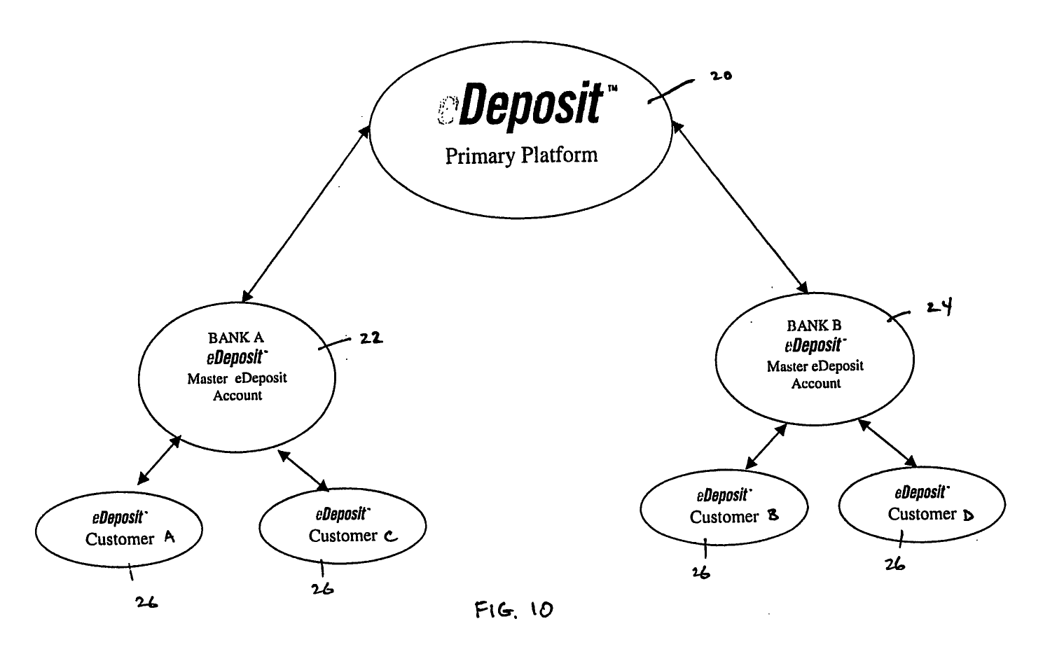

In an alternative or additional embodiment of the present invention, similar transactions may be encompassed between customers in an interdepository environment where multiple sub-accounts are administered by the depository administrator via master accounts at multiple financial institutions. In this manner, customers of different banks can transfer funds between their accounts through the present invention system functionality. In one arrangement, with reference to FIG. 10, the depository administrator maintains a primary platform 20 that in turn administers master accounts 22, 24, etc. at different financial institutions. Each master account 22, 24 may incorporate a plurality of deposit sub-accounts 26 for its customers. This arrangement may also be affiliated with a user's existing bank account as a component feature for administration via the depository administrator. That is, the user's bank may offer the system functionality to existing customers, enabling the users to establish a deposit sub-account using funds from their existing account through the bank itself or the system administrator.

Using the primary platform 20, the depository administrator can consolidate fund transfers and other transactions of its customers while limiting if not eliminating the amount of actual funds transferred between master accounts 22, 24, etc. For example, assume customer A whose deposit sub-account is administered via master account 22 desires to transfer funds to customer B whose deposit sub-account is administered via master account 24. In a similar context, assume customer D whose deposit sub-account is administered via master account 24 intends to transfer the same amount to customer C whose deposit sub-account is administered via master account 22. The primary platform 20 can recognize this equal transfer and effect respective debits of customers A and D's deposit sub-accounts 26 and credits to customers B and C's deposit sub-accounts 26 without physically transferring funds between banks or even affecting the balance of either master account 22, 24. On a global scale, the primary platform 20 can maintain a plurality of master accounts to thereby service customers having bank accounts at various banks.

With the system of the present invention, users can more easily deposit or withdraw funds from their own account or effect a transfer of funds to another account via Internet access to the depository administrator. As a consequence, time constraints and other inconveniences associated with the current fund transfer vehicles can be eliminated.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of processing funds between a transferor and a transferee, at least the transferor having a transferor deposit sub-account administered via a depository administrator, the method comprising:
(a) the transferor accessing the depository administrator via a global network;
(b) the transferor requesting a transfer or hold of funds in the transferor deposit sub-account to or for the benefit of the transferee;
(c) if the transferee does not have a transferee deposit sub-account administered via the depository administrator, providing the transferee an opportunity to establish the transferee deposit sub-account; and
(d) the depository administrator processing the funds between the transferor deposit sub-account and the transferee deposit sub-account.

2. A method according to claim 1, wherein step (b) further comprises enabling the transferor to input an E-mail address of the transferee, and wherein the method further comprises alerting the transferee via E-mail that the transfer or hold of finds has been requested.

3. A method according to claim 2, wherein step (c) is practiced by the depository administrator comparing the transferee E-mail address with stored E-mail addresses of deposit sub-account holders to thereby determine whether the transferee has an existing transferee deposit sub-account.

4. A method according to claim 3, wherein if the transferee does not have a transferee deposit sub-account administered via the depository administrator, the step of alerting the transferee via E-mail further comprises providing a link to the depository administrator enabling the transferee to establish the transferee deposit sub-account.

5. A method according to claim 3, wherein if the transferee has a transferee deposit sub-account administered via the depository administrator, the step of alerting the transferee via E-mail further comprises providing a link to the transferee deposit sub-account.

6. A method according to claim 1, wherein step (d) is practiced by holding the funds in the transferor deposit sub-account until receiving confirmation that an event has occurred.

7. A method according to claim 6, wherein the confirmation that an event has occurred comprises confirmation by the transferor.

8. A method according to claim 6, wherein the confirmation that an event has occurred comprises confirmation of product delivery.

9. A method according to claim 6, wherein the confirmation that an event has occurred comprises confirmation of service completion.

10. A method according to claim 1, wherein the depository administrator maintains multiple master accounts at multiple financial institutions, and wherein step (d) is practiced by internally processing the funds between the transferor deposit sub-account as part of one master account and the transferee deposit sub-account as part of a different master account.

11. A method according to claim 1, further comprising issuing automated teller machine (ATM) cards to holders of deposit sub-accounts, and enabling the transferor and transferee to deposit funds or withdraw available funds via their respective ATM cards.

12. A method according to claim 11, further comprising, prior to step (a), the transferor depositing funds into the transferor deposit sub-account using the transferor's ATM card, and after step (d), the transferee withdrawing funds from the transferee deposit sub-account via the transferee's ATM card.

13. A method according to claim 11, further comprising, after step (d), the transferee withdrawing funds from the transferee deposit sub-account via the transferee's ATM card.

14. A method according to claim 1, wherein the depository is a bank.

15. A method according to claim 1, wherein the depository is a retail establishment.

16. A computer system for processing funds between a transferor and a transferee, at least the transferor having a transferor deposit sub-account administered via a depository administrator, the computer system comprising:
at least one user computer running a computer program that enables the transferor to access the depository administrator to request a transfer or hold of funds in the transferor deposit sub-account to or for the benefit of the transferee; and
a system server running a server program, the at least one user computer and the system server being interconnected by a computer network, the system server processing the funds between the transferor deposit sub-account and the transferee deposit sub-account, wherein if the transferee does not have a transferee deposit sub-account administered via the depository administrator, the system server providing the transferee an opportunity to establish the transferee deposit sub-account.

17. A computer program embodied on a computer-readable medium for processing funds between a transferor and a transferee, at least the transferor having a transferor deposit sub-account administered via a depository administrator, the computer program comprising:
means for the transferor to access the depository administrator via a global network;
means for the transferor to request a transfer or hold of funds in the transferor deposit sub-account to or for the benefit of the transferee;
if the transferee does not have a transferee deposit sub-account administered via the depository administrator, means for providing the transferee an opportunity to establish the transferee deposit sub-account; and
means for the depository administrator to process the funds between the transferor deposit sub-account and the transferee deposit sub-account.
